(19) United States
(12) Patent Application Publication
(10) Pub. No.: US 2005/0111056 A1
(43) Pub. Date: May 26, 2005

(54) Image reader

(75) Inventors: Hirotaka Chiba, Kawasaki (JP); Tsugio Noda, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMTED, Kawasaki (JP)

(21) Appl. No.: 10/753,566

(22) Filed: Jan. 9, 2004

(30) Foreign Application Priority Data
Jan. 30, 2003 (JP) 2003-022828

(51) Int. Cl. H04N 1/024

(52) U.S. Cl. 358/474; 358/473

(57) ABSTRACT

An image reader, detachably attached to an electronic apparatus, which scans and reads an image formed on a surface to be read includes an image reading part that reads the image; and a scan amount detection part that detects a scan amount by the image reading part, the scan amount detection part including a scaler that is arranged oblique to a vertical scanning direction orthogonal to a horizontal scanning direction, and moves along with scanning by the image reading part.

This application claims a benefit of foreign priority based on Japanese Patent Application No. 2003-022828, filed on Jan. 30, 2003, which is hereby incorporated by reference herein in its entirety as if fully set forth herein.

### BACKGROUND OF THE INVENTION

The present invention relates generally to electronic apparatuses, and more particularly a peripheral for the electronic apparatus. The present invention is suitable, for example, for an image pick-up device for functionally expanding a portable information terminal, such as a personal digital assistant (“PDA”).

A device for reading images on a medium has conventionally been widely known as a scanner, and miniature scanners have been proposed suitable for portability. A portable scanner, different from other peripherals, such as a digital camera, requires a user to move the scanner on the medium, and thus is demanded to provide good operability, e.g., smooth scanning and easy read control operations.

A scanner part when connected to the PDA through an interface such as a CF slot may use a console part, a memory, and an indicator on the PDA and receive the power from the PDA. For example, Japanese Patent Application Publication No. 7-283910 discloses an image reader including a PC card and a scanner. Thereby, the cable may be omitted by using the CF card, and the obtained image may be confirmed as image data on site.

A scanner that may be inserted into a PDA through a CF card slot and a PC card slot is also required to be small, thin and lightweight in addition to being as operable as the PDA. Typically, the PDA itself extends in a perpendicular direction and has a console part at its lower portion, while the CF slot is adapted to be inserted into the PDA from the top. Consequently, when the CF card with a scanner function is inserted into the PDA, the scanner part is located up when the console part is located down.

In reading images with this PDA, the PDA is turned up side down so that the scanner part is at the bottom to scan the medium. Problematically, holding the PDA near the scanner greatly deteriorates operability because switching actions to start and end reading at the console part become apart from the scanner part.

In addition, the conventional scanner is wider than the PDA (i.e., in a vertical scanning direction), and an operator has a difficulty in holding the PDA near the scanner and suffers from bad-operability. Wide scanners when-attached to the PDA deteriorate portability and storage easiness, and thus narrower scanners have been demanded.

### BRIEF SUMMARY OF THE INVENTION

With the foregoing in mind, it is an exemplary object of the present invention to provide an image reader that facilitates miniaturization and reduces its width (i.e., in a vertical scanning direction).

In order to achieve these and other objects, an image reader of one embodiment according to the present invention, detachably attached to an electronic apparatus, which scans and reads an image formed on a surface to be read includes an image reading part that reads the image, and a scan amount detection part that detects a scan amount by the image reading part, the scan amount detection part including a scaler that is arranged oblique to a vertical scanning direction orthogonal to a horizontal scanning direction, and moves along with scanning by the image reading part.

According to this configuration, the scaler (and, for example, a line pattern, formed on its surface, which detects a scan amount of the image reading part) inclines relative to the vertical scanning direction orthogonal to the horizontal scanning direction, and reduces its size in the vertical scanning direction. Even when the scaler forms the line pattern that detects rotations, the line length does not limit the miniaturization of the scaler in the vertical scanning direction. The reduced size of the scaler in the vertical scanning direction may reduce the size of the entire image reader in the vertical scanning direction, improving operability and portability of the image reader.

The image reader can improve its linear stability upon scanning in reading images without enlarging the image reader, for example, with the enlarged main roller in the vertical scanning direction which contacts and rotates on the medium in scanning images on the medium and the reduced scaler in the vertical scanning direction.

The reading area increases without enlarging the image reader with an increased reading width of the reading sensor used to read images and the reduced scaler in the vertical scanning direction.

The above effect enhances when the scaler is arranged orthogonal to the vertical scanning direction. The extremely reduced size of the scaler in the vertical scanning direction sufficiently reduces the size of the image reader in the vertical scanning direction.

The scaler with a radial line pattern results in accurate detections of rotations of the scaler. The scan amount detection part can increase resolution with an enlarged diameter of the scaler with fine line pattern.

The image reader that further includes a rotary shaft that extends in the vertical scanning direction, and a main roller provided around the rotary shaft and integrated with the scaler reduces rotational shifts between the main roller and the scaler, and enables accurate detections of the scan amount of the image reading part. Their integral combination before an attachment to the housing of the image reader provides an effect of the improved assembly operation of the image reader.

The image reader that further includes a housing that accommodates the image reading part, wherein the main roller is located outside of the housing and larger than the housing may enlarge a diameter of the scaler integrated with the roller. When the housing accommodates the roller and the scaler, their diameters are hard to be larger due to the restrictions of the inner size of the housing. On the other hand, the roller and the scaler provided outside of the housing become larger without restriction of the housing. As a result, the scan amount detection part may increase the resolution and accurately detects the scan amount of the image reader.

The image reader may further include a housing that accommodates the image reading part, the housing having a dent, a main roller that moves the housing in the horizontal scanning direction, a boss formed at a center of the main roller and engageable with the dent provided on the housing, and a bearing formed around the boss, wherein the scaler is formed around the bearing.

This configuration facilitates assembly because the boss of the main roller is engaged with the bearing and the hole in the housing. For example, when the scaler forms a center hole into which the boss of the main roller is inserted, the scaler and the main roller are assembled easily and the image reader is assembled easily. When the center hole of the scaler is engaged with the boss of the main roller, these centers may be precisely aligned with each other.

An image reader of another aspect according to the present invention, detachably attached to an electronic apparatus, which scans and reads an image formed on a surface to be read includes an image reading part that reads the image, and a scan amount detection part that detects a scan amount by the image reading part, the scan amount detection part including a photo detector part, which arranges oblique to a horizontal scanning direction an exit surface that detects detection light that optically detects the scan amount.

Since this configuration arranges the exit surface of the photo detector orthogonal to the horizontal scanning direction, the photo detector, such as a sensor or sensor board including a reflection-type optical sensor, may be shorter in the vertical scanning direction. The reduced size of the photo detector in the vertical scanning direction may reduce the size of the entire image reader in the vertical scanning direction, improving operability and portability of the image reader.

The image reader can improve its linear stability upon scanning in reading images without enlarging the image reader, for example, when the main roller that contacts and rotates on the medium in scanning images on the medium is enlarged in the vertical scanning direction with the reduced size of the photo detector in the vertical scanning direction.

The reading area increases without enlarging the image reader when the reading sensor has an increased reading width used to read images with the reduced size of the photo detector in the vertical scanning direction.

The above effect enhances when the exit surface is arranged orthogonal to the vertical scanning direction. In general, a sensor used for the photo detector has a larger sensor board than a distance from the target necessary for detection. In other words, the image reader may reduce its size in the vertical scanning direction by arranging the exit surface in the vertical scanning direction and a surface of the sensor surface orthogonal to the vertical scanning direction.

The image reader that further includes a positioning part that positions the photo detector part easily and securely position the photo detector in assembling this image reader. This improves the assembly operation of the image reader and the reading, accuracy, and, reading accuracy.

The scan amount detection part may further include a scaler arranged oblique to a vertical scanning direction orthogonal to the horizontal scanning direction, and the scaler moving along with scanning by the image reading part, wherein the image reader further comprises a housing that accommodates the image reading part and the photo detector part, and wherein the scaler is arranged outside the housing, while the positioning part is formed on the housing between the photo detector part and the scaler, and includes a transmission window that transmits the detection light.

The scan amount detection part inclined relative to the vertical scanning direction orthogonal to the horizontal scanning direction may miniaturize the image reader in the vertical scanning direction, as discussed above. The scan amount detection part that includes a scaler that moves with scanning of the image reader part can securely detect the scan amount by this image reader, improving reading accuracy.

Since the housing accommodates the image reading part and the photo detector, the image reader may reduce its size in the vertical scanning direction, eliminate an unnecessary projection outside the housing, and improve the operability and portability. The scaler may be enlarged when arranged outside of the housing, and improve the resolution of the scan amount detection part and reading accuracy. Since the positioning part is formed on the housing between the photo detector part and the scaler and includes a transmission window that transmits the detection light, the photo detector part may be easily and precisely positioned and the detection light for the photo detector part is prevented from being shielded by the housing.

An image reader of another aspect according to the present invention, detachably attached to an electronic apparatus, which scans and reads an image formed on a surface to be read includes an image reading part that reads the image, a scan amount detection part that detects a scan amount by the image reading part, the scan amount detection part including a scaler that moves along with scanning by the image reading part, a rotary shaft that extends in a vertical scanning direction orthogonal to a horizontal scanning direction, and a main roller provided around the rotary shaft, wherein the scaler is integrated with the main roller.

This configuration integrates the scaler with the main roller, reduces the number of components, and facilitates cost reduction of this image reader. The integration facilitates a low profile and miniaturization of the image reader.

The scaler may be arranged adjacent to and integrated with a side of the main roller, and includes a radial line pattern. Thereby, the scaler and the main roller can be made thinner, and the image reader may be shorter in the vertical scanning direction.

Other objects and further features of the present invention will become readily apparent from the following description of the embodiments with reference to accompanying drawings.

### BRIEF DESCRIPTION OF THE DRAWINGS

FIG. 1 is a perspective overview of an image reader of one embodiment according to the present invention.

FIG. 2 is a perspective overview of the image reader shown in FIG. 1 mounted on a PDA as an exemplary electronic apparatus.

FIG. 3 is another perspective overview of the image reader shown in FIG. 1.

FIG. 4 is a block diagram showing a control system of the image reader shown in FIG. 4.

FIG. 5 is a schematic sectional view showing a structure of an image reading part in the image reader shown in FIG. 1.

FIG. 6 is a perspective overview showing that a reinforcing member is being inserted into a CF card in the image reader shown in FIG. 1.

FIG. 7 is an exploded perspective view for explaining an arrangement among a housing, an image reading part, a pair of main rollers, and a shaft in the image reader shown in FIG. 1.

FIG. 8 is a perspective view of the main rollers in the image roller shown in FIG. 1.

FIG. 9 is a perspective view showing a structure of an auxiliary roller in the housing in the image reader shown in FIG. 1.

FIG. 10A is a partial perspective overview showing a projection member provided in the read window on the image reader shown in FIG. 1.

FIG. 10B is a schematic side view showing a relationship among a main roller, an auxiliary roller, and a projection roller.

FIG. 10C is a side view of the image reader shown in FIG. 1 showing the projection member by removing the main rollers.

FIG. 11 is a perspective view from the outside to the inside of the housing showing an essential internal structure of a scan amount detection part of the image reader shown in FIG. 1.

FIG. 12 is a perspective view from the inside to the outside of the housing showing an essential internal structure of the scan amount detection part of the image reader shown in FIG. 1.

FIG. 13 is an exploded perspective view of the image reader shown in FIG. 1.

FIG. 14 is a perspective view showing a structure that arranges the roller and image sensor in parallel.

FIG. 15 is a perspective overview of the image sensor shown in FIG. 14.

FIG. 16 is a sectional view of the image sensor shown in FIG. 14.

FIG. 17 is a perspective view showing an essential internal structure near the scan amount detection part in an image reader as a variation of the present invention.

### DETAILED DESCRIPTION OF THE INVENTION

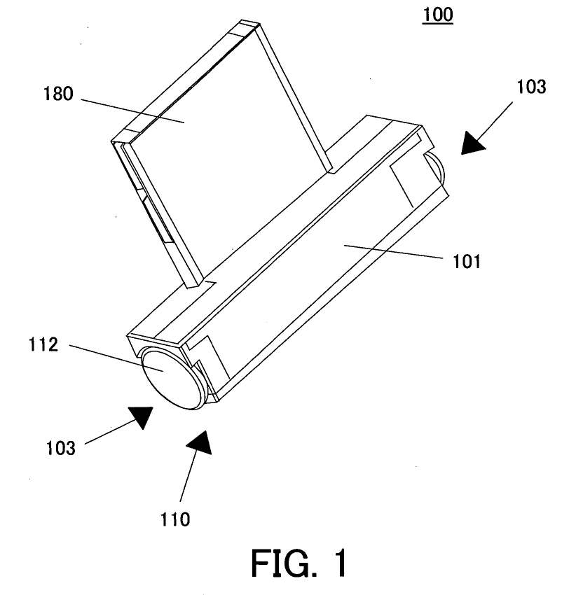

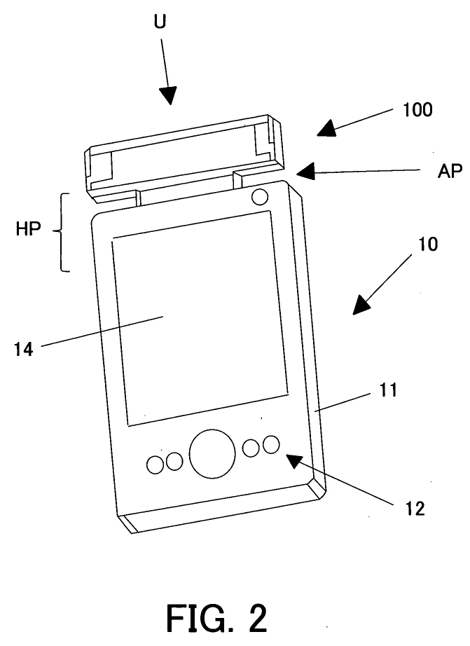

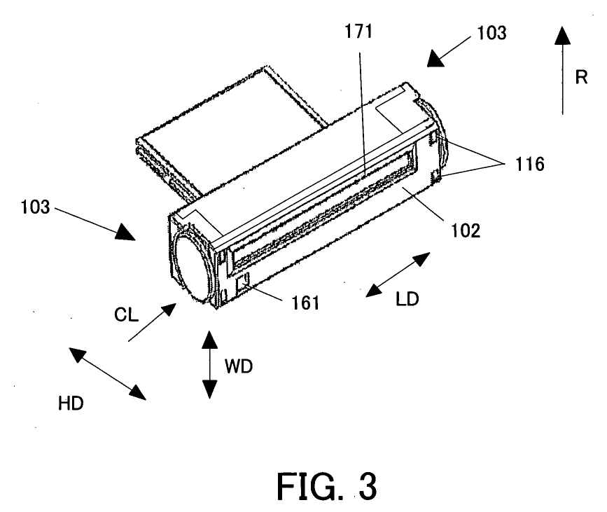

Referring now to accompanying drawings, a description will be given of an image reader 100 of one embodiment according to the present invention. Here, FIG. 1 is a perspective overview of the image reader 100. The image reader 100 is adapted to scan and read images on a surface to be read of a medium. FIG. 2 is a perspective overview of the image reader 100 mounted on a PDA 10 as an exemplary electronic apparatus. FIG. 3 is another perspective overview of the image reader 100.

Although the instant embodiment uses the PDA 10 as a typical example of the electronic apparatus, electronic apparatuses to which the present invention is applicable include a hand-held PC, palm sized PC, wearable computer, portable electronic apparatus, portable terminal, etc., and its size covers an A4 size, a B5 size, a sub-notebook size, a mini-notebook size, etc.

The PDA 10 includes an approximately rectangular parallelopiped housing 11, a console part 12, a display part 14, a CF slot (not shown) provided on the rear surface of the housing 11, and a memory (not shown) accommodated in the housing 11. The CF slot (not shown) is formed at the rear surface so that the CF card 180 may be inserted from the top in a direction U shown in FIG. 2.

If necessary, the PDA 10 may have a pen, a USB port, a radio communication antenna (not shown), a radio LAN card, a speaker, an Ir receiver, an outer microphone, a headphone connector, a radiator part, an AC adapter terminal, an IrDA port, a battery part, various pointing devices, a bluetooth modem, other connectors with peripherals, a security part of the device housing.

If necessary, the PDA 11 serves as a stand for maintaining a predetermined inclined orientation on a table or desk. The present invention does not prevent the PDA 10 from being detachably mounted on an optional dedicated support rack as a separate member.

The console part 12 includes various LEDs, a power switch, a reset switch, various control switches. The LEDs include lamps, for example, for indicating a battery volume, a connection status with the external power supply, a communication status, a status of the image reader 100, an access to the memory, an abnormality of the PDA 10, etc. The power switch is a switch used to power on and off the PDA 10. The reset switch is a switch used to resume the PDA 10. Various control switches enable a user to control the PDA 10 itself and the image reader 100, if necessary. Such control includes driving, scanning start and stop, display, storage, editing of image information.

The display part 14 includes, for example, an LCD. If necessary, the display part 14 is formed as a touch panel for indicating a plurality of electronic buttons and for inputting information into the PDA 10 using a finger or pen. The display part 14 may display various data including various control information to the PDA 10 and image reader 100, entry information, and Web information as well as image information sent from the image reader 100.

The console part 12 and display part 14 may use any techniques known in the art, and a detailed description thereof will be omitted. The memory (not shown) in the PDA stores image information received from the control part 107, which will be described later.

Before the image reader 100 is not installed, a user typically puts a rear surface near the console part 12 on the PDA 10 on his/her palm, as shown in FIG. 2, while placing the console part 12 down and the display part 14 up, and operates the console part 12 with his/her right hand. On the other hand, when the image reader 100 is mounted onto the PDA 10, the user positions the image reader 100 on a medium, such as a book and manuscript, and a user holds the PDA 10 with his hand. Therefore, it is understood that in using the image reader 100, the holding part is located near a part HP in PDA 10 in FIG, 2 apart from the console part 12.

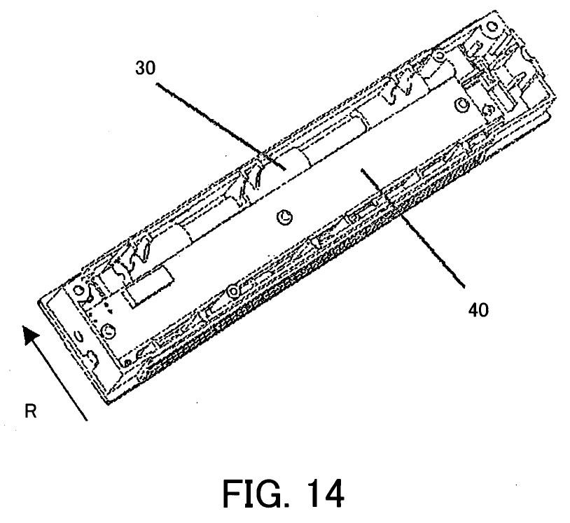

The image reader 100 is one example of a functional expansion, device, detachably attached to the electronic apparatus, for functionally expanding the electronic device, and this embodiment provides the PDA 10 with an image reading function to read out an image on a medium. Of course, some characteristics of the present invention are applicable to functional expansion devices other than the image reader, which include an image pick-up device, such as a digital camera, a GPS device, and a radio communication apparatus, such as a GPS. The image reader 100 of the instant embodiment includes a housing 100, a drive mechanism 110, a scan amount detection part 140, a medium detecting part 160, an image reading part 170, and a CF card 180. The image reading part 170 is built in the housing 101 and adapted to read images on the medium (see FIG. 14B).

The housing 101 serves as a scanner, and has an approximately rectangular parallelopiped shape. The housing 101 includes an image-reading surface 102, a pair of side surface 103, and a PDA facing surface 104. The image-reading surface 102 is a surface that faces a medium, such as a book and manuscript. The image reading surface 102 is provided with four auxiliary rollers 116, a read window 171, a detector window 161. A concave portion is formed on each side surface 103, and a main roller 112 is engaged with the concave portion. This main roller 112 provides rolling contacts between its circumferential surfaces and the medium surface when the image reading part 170 scans the medium surface. The PDA facing surface 104 is a surface that faces the PDA 10.

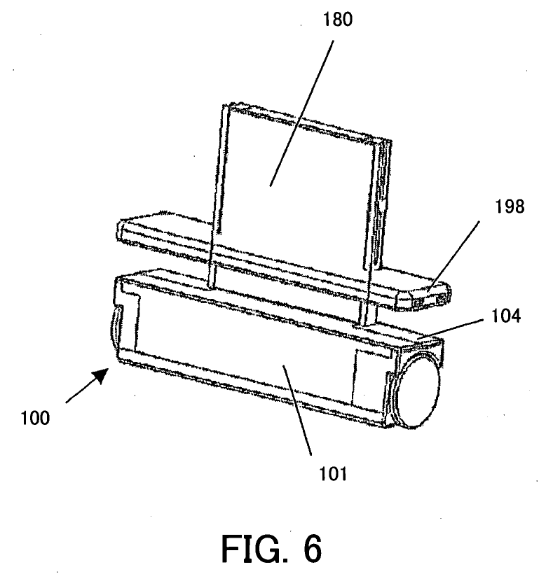

As shown in FIG. 6, a reinforcing member 198 made of an elastic material, such as rubber, is detachably provided between the housing 101 and the PDA 10. Here, FIG. 6 is a perspective overview showing that the reinforcing member 198 is being inserted into the CF card 180. The reinforcing member 198 finally contacts the PDA facing surface 104. The elastic material is used to absorb a shape change to some extent because the PDA facing surface 104 sometimes includes a curved surface and projections, such as body switches, and is not always flat. The instant embodiment enables the reinforcing member 198 to be detachably inserted into the aperture AP, but may fix it with adhesive agent.

The aperture AP shown in FIG. 2 may be eliminated when the CF card 180 is squeezed further, but remains depending upon device types of the PDA 10 to which the image reader 100 is connected. The reinforcing member 198 is located in the aperture between the PDA facing surface 104 on the housing 101 of the image reader 100 and the PDA 10, and serves to make the housing 101 contact with the PDA 10. Such an aperture AP would apply the bending stress to the CF card 180 and damage the CF card 180 in scan reading, since only the CF card 180 is located in the aperture. On the other hand, the PDAs 10 have different CF slot depths depending upon manufactures and the aperture distance changes depending upon device types. The instant embodiment make the image reader 100 compatible with a device type with the deepest CF slot in order to make the image reader 100 compatible with various device types. Then, the aperture AP of several mm, e.g., about 2 to 5 mm occurs between the PDA facing surface 104 and the PDA 10 for other devices types. Accordingly, plural reinforcing members each having a different thickness are prepared and one which corresponds to the aperture is selected for each device type, so as to make the image reader 100 compatible with multiple device types of PDAs 10.

The drive mechanism 110 is a mechanism for enabling the user to move the image reader 100 on the medium. The drive mechanism 110 includes a pair of rollers 112, a shaft for connecting the main rollers 112, four auxiliary rollers 116, and a pair of shafts 118 each for pivoting a pair of auxiliary rollers 116.

The main roller 112 serves to move the housing 101 on the medium, and the image-reading surface on the housing 101 projects in a medium direction, for example, by 0.5 mm. The main rollers 112 are rotatably provided on a pair of side surfaces 103 perpendicular to the image-reading surface 102 on the housing 101, and connected by the shaft 114. The rollers 112 may be made thin by arranging the main rollers at both sides of the housing 101 through the shaft 114. The image reader 100 may be made shorter in the direction R than the rollers arranged with the image reading part 170 in an image read (or scan) direction R. Such a low profile assists in equalizing the thickness of the PDA 10 to the thickness of the image reader 100.

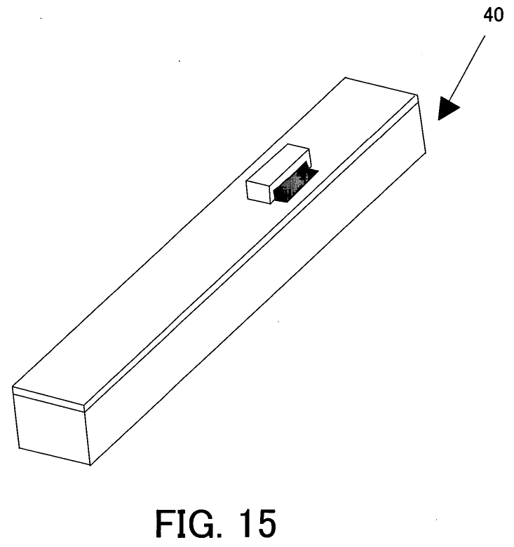

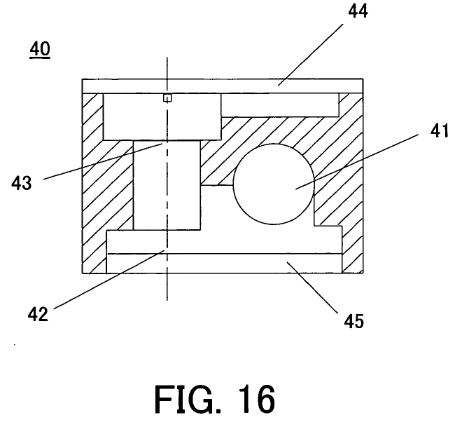

Suppose, for example, that one or more rollers 30 are arranged with an image sensor unit 40 in the read direction R, as shown in FIG. 14. Here, FIG. 14 is a perspective view of the structure that arranges the rollers 30 and image sensor unit 40 in parallel. In addition, FIGS. 15 and 16, respectively, are a perspective overview and a sectional view of the image sensor unit 40. The image sensor 40 includes, as shown in FIGS. 15 and 16, a light source 41, a lens array 42 for imaging reflected light from the medium on a sensor surface, a sensor chip 43, such as a CCD, a control board 44 for processing and controlling signals from the sensor chip 43, and a transparent protective cover 45. The image sensor unit 40 is unitized and thus the rollers 30 should be arranged by avoiding the image sensor unit 40. For example, when the rollers 30 are arranged as shown in FIG. 14 the device size should be extended longer than the diameter of the roller 30.

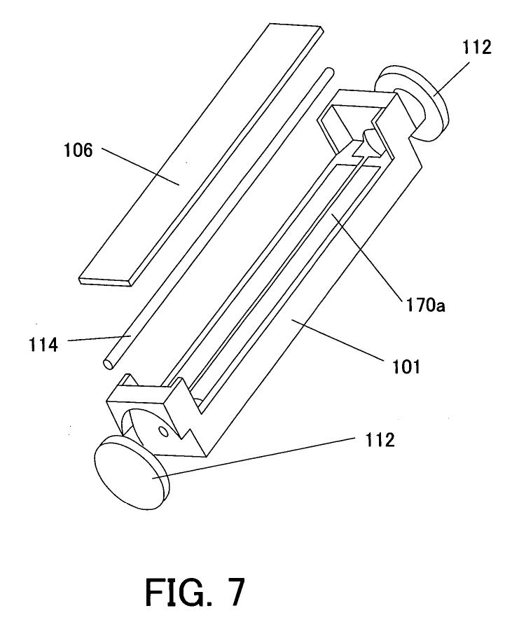

On the other hand, the instant embodiment arranges the main rollers 112 and image reading part 170 in series as shown in FIG. 7, while allows the shaft 114 to perforate the image reading part 170. Here, FIG. 7 is an exploded perspective view for explaining an arrangement among the housing 101, image reading part 170, main rollers 120, and shaft 114. The instant embodiment fixes main rollers 112 with the shaft 114, synchronizes the rotations of the main rollers 112, and mitigates the meander during scanning. In addition, the image reader 100 may be made smaller in the direction R than the structure shown in FIG. 14. Moreover, only one encoder is enough to measure the rotation.

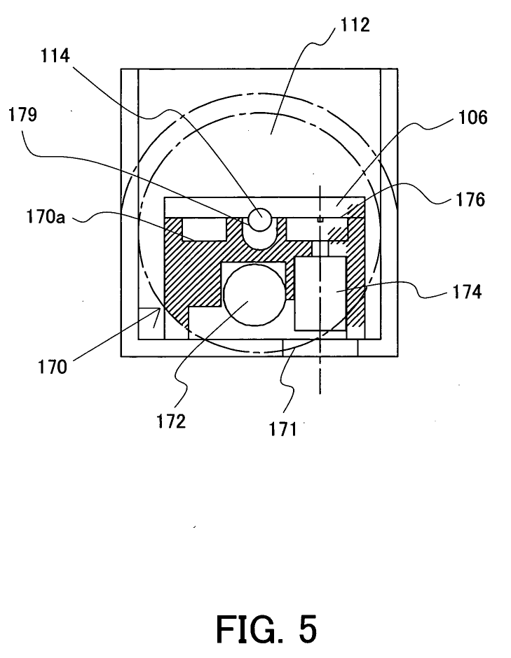

As shown in FIG. 5, the shaft 114 perforates a perforation hole 179 in a unit housing 170a in the image reading part 170. If the shaft 114 does not perforates the housing 170a in the image reading part 170 and located on the housing 170a, the diameter of the roller and thus the image reader 100 become larger in the height direction HD. As a result, a position of the center of gravity becomes higher, lowering the stability of the scan movement. In addition, such a structure enlarges the moving distance per one roller rotation and requires a high-resolution rotary encoder for detecting the moving distance of the roller.

Therefore, the instant embodiment solves these problems by enabling the shaft 114 to perforate the perforation hole 179 in the image reading part 170. This structure may miniaturize a structure that arranges the roller and shaft while avoiding the image reading part 170. The shaft 114 in this embodiment has the same uniform diameter along its span. In assembling the shaft 114 inside the image reading part 170, it is conceivable to provide stages for correcting positional offsets of the rollers 112. Since the image reading part 170 is unitized, the control board 106 for the image reading part 170 should be disassembled once and then reassembled. However, this would cause the image reading part 170 to break and deteriorate its performance and it is preferable to avoid disassembly of the image reading part 170. The shaft 140 having the same diameter over its span would prevent the image reading part 170 from being disassembled since the shaft 114 may be inserted into the housing 170a from its side surface.

Each main roller 112 has a plurality of projections 112a at the side of the housing 101, as shown in FIG. 8. Here, FIG. 8 is a perspective view of the main rollers 112. The shaft with the same diameter over its span cannot fix a position of the main roller 112 using bearings on the shaft. With the large tolerance and the large clearance among components, the roller 112 becomes rickety. The strict size enough to make small the clearance would increase cost, while the smooth rotation of the rollers 112 deteriorate due to friction resulting from a contact between the rollers 112 and housing 101. Accordingly, the instant embodiment provides a plurality of projections 112a on a surface of the main roller 112, and lowers the friction even when there is a contact between the main roller 112 and the housing 101 because the contact becomes point contacts. In addition, the clearance may be made small even in the design.

As discussed later, the instant embodiment provides bearings 114a between the main roller 112 and the housing 101, and spaces the main roller 112 and the housing 101 by a predetermined distance. Indeed, the projections 112a seldom contact the housing 101 for smaller rotational friction.

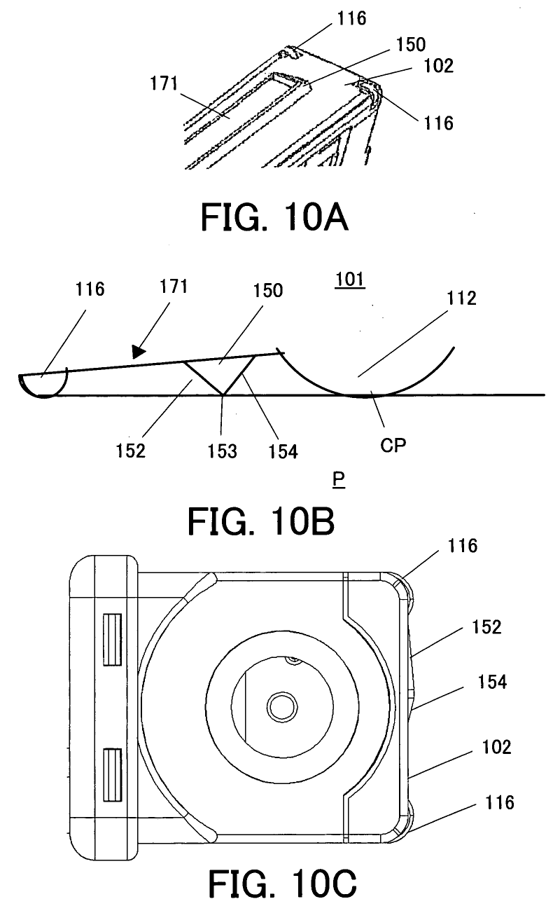

The instant embodiment provides four auxiliary rollers 116 at four corners of the image-reading surface 102, as shown in FIG. 3. While the instant embodiment arranges the main rollers 112 in the longitudinal direction LD of the image reader 100, a pair of main rollers 112 contact the medium at two points, and these two points are located just below the center line CL of the image-reading surface 102. In other words, the image-reading surface on the housing 101 may incline back and forth with respect to the line connecting two contacts between the main rollers 112 and the medium (or two points CP in FIG. 10B which will be described later). Accordingly, the auxiliary rollers 116 are provided to maintain the image-reading surface 102 parallel to the medium even when a force applies which would otherwise incline the image-reading surface.

The auxiliary rollers 116 project from the image-reading surface 102 of the housing 101 in the medium direction, for example, by 0.3 to 0.4 mm. The projecting amount of the auxiliary roller 116 from the image-reading surface 102 is made smaller than that for the main roller 112 so as to make the main roller 112 contact with the medium certainly even with somewhat manufacture errors. A provision of a plurality of auxiliary rollers 116 may facilitate maintaining the image-reading surface 102 parallel to the medium and smooth scan.

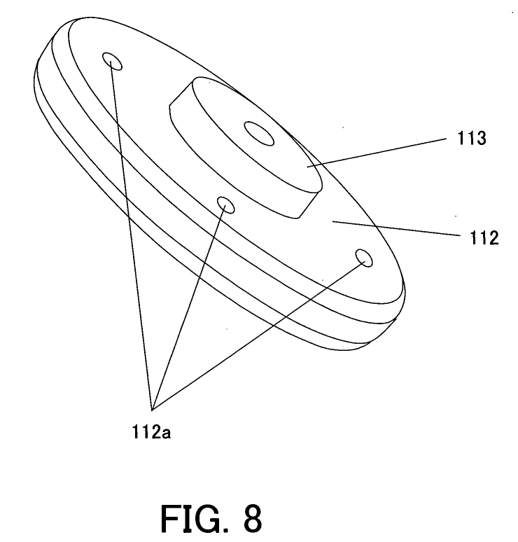

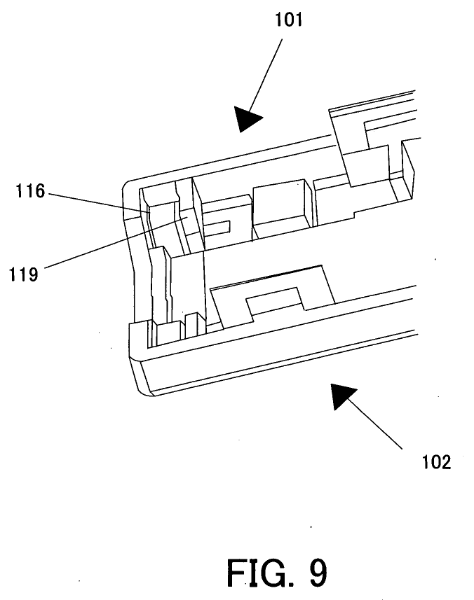

The auxiliary roller 116 is made of a hollow roller and the shaft 118. The shaft 118 is accommodated in the housing 101. As shown in FIG. 9, the shaft 118 may be veiled from the outside in an assembly structure that inserts the shaft 118 into the shaft insertion opening 119 in the housing 101. Here, FIG. 9 is a perspective view inside the housing for explaining the attachment of the auxiliary rollers 116. The auxiliary rollers 116 rotate around the shaft 118. The appearance of the housing 101 may be simplified by preventing the housing 101 from exposing, and the fixture of the shaft 118 using other components would realize the simple structure.

The medium detecting part 160 is provided within the housing 101, and forms an optical system for detecting whether the medium, such as a book and manuscript, exists near the image-reading surface 102 of the image reading part 170 within a predetermined distance through the detector window 161 shown in FIG. 3. The medium detecting part 160 is made of a photo sensor, such as a photo-interrupter, and the detector window 161 is attached near the read window 171 in the image-reading surface 102.

Although the present invention does not limit the medium detecting part 160 to the photo sensor, the photo sensor detects the medium in a non-contact manner and is expected to provide the image reader 100 with the longer life since there is no friction and impact with the medium associated with a mechanical switch for detecting the medium in a contact manner.

According to the medium detector part 160, a user does not have to operate the console part 12 on the PDA 10 and set the image reading part 170 to a standby state. Rather, the image reading part 170 may start and stop reading without requiring a user to release his/her hand that holds the image reader 100 and the PDA 10 on the medium.

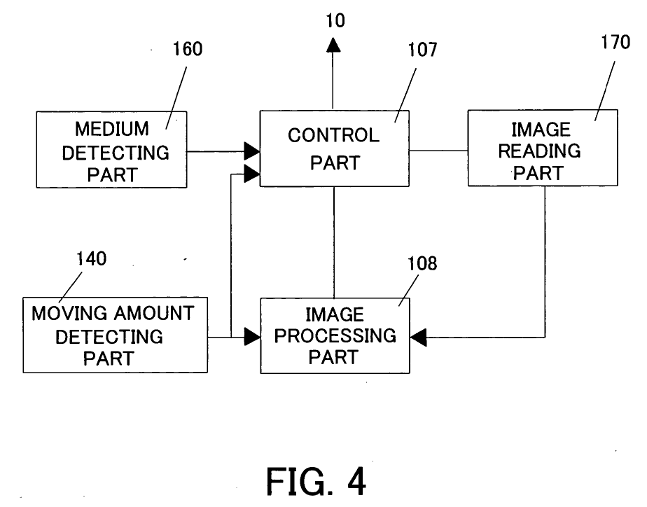

As shown in FIG. 4, the image reader 100 includes, as a control system, the control part 107, the image processing part 108, the scan amount detection part 140, the medium detecting part 160, and the image reading part 170. Here, FIG. 4 is a block diagram showing a control system of the image reader 100. As described later, the scan amount detection part 140 detects the scan amount by the image reading part 170 in the image reader 100 on the medium. The medium detector 160 outputs to the control part 107 an ON signal when detecting the medium and an OFF signal when detecting no medium. In response to a drive signal as a trigger input from the control part 107, the image reading part 170 reads in one line image on the medium and outputs this as image data to the image processing part 108. The control part 107 supplies a drive signal to the image reading part 170 in accordance with a detection result by the scan amount detection part 140, and controls timing for reading the image by the image reading part 170. The medium detecting part 160 sends a drive signal to the image reading part 170 when receiving an ON signal from the medium detecting part 160. The image processing part 108 digitizes analog image data input from the image reading part 170. The control part 107 sends the image data processed by the image signal processing part 108 to the PDA 10, and enables the display part 14 to display the information and the console part 12 to edit the information.

The image reading part 170 is provided inside the housing 101, as an image sensor unit for reading an image on the medium through the read window shown in FIG. 3. The image reading part 170 includes, as shown in FIG. 5, a light source 172, a lens 174, and a sensor chip 176, and is protected by the transparent protective cover 177. Here, FIG. 5 is a schematic sectional view of the housing 101 showing the structure of the image reading part 170. As shown in FIG. 5, the light source 172, lens 174, and sensor chip 176 are unitized in the housing 170a. In addition, the housing 170a includes the perforation hole 179 for the shaft 114, as described above.

Referring to FIG. 3, the read window 171 is formed in the image-reading surface 102 so that it extends in the longitudinal direction LD of the image-reading surface 102. The image reading part 170 reads an image on the medium through the read window 171. The read window 171 is formed and decentered in the forward read direction R of the image with respect to the center line CL orthogonal to the width direction WD of the image-reading surface 102 (although the center line CL in FIG. 3 does not extend to the image-reading surface 102 for illustration purposes). The CF slot is provided at the rear surface of the housing 11 for the display part 14 of the PDA 10. In scanning after the image reader 100 is inserted into the CF slot with the display part 14 facing front, the opposite end to the CF card 180 faces the read direction R of the image and is arranged at a position shown in FIG. 3. A bias of the read window 171 to the end of the image-reading surface 102 would facilitate matching the actual reading start position to the expected one, improving the operability. In other words, when the read window 171 is located at the center, a user should account for the distance between the center and the end on the image-reading surface 102. However, the end may be aligned with the image reading position in the structure shown in FIG. 3. In particular, in reading a center foldable position in a book, the image reader 100 may read a portion closer to the center of the book than that having a read window at the center in the width direction WD on the image-reading surface 102.

The read window 171 is provided with the projection member 150. A description will now be given of the projection member 150 with reference to FIG. 10. Here, FIG. 10A is a partial perspective overview of the projection member 150 provided on the read window 171. FIG. 10B is a schematic side view showing a relationship among the main roller 112, auxiliary roller 116, and projection member 150 when the image-reading surface 102 on the housing 101 inclines relative to the medium. FIG. 10C is a side view of the housing 101 without the main rollers 112 in order to show the projection member 150. FIG. 10A omits the main roller 112 for illustration purposes.

As described above, the image-reading surface 102 on the housing 101 is provided with the auxiliary rollers 116 so as to maintain parallelism since it is inclinable with respect to two points CP at which a pair of main rollers 112 contact the medium P. The points CP is located just below the centerline orthogonal to the width direction WD on the image-reading surface 102. A gap is provided between the image-reading surface 102 and the medium P for smooth rotations of the rollers 112 and 116. However, if the medium P is not maintained flat, a height of the medium P from the read window 171 changes and high quality of images cannot be obtained. Accordingly, the projection member 150 is provided near the read window 171 to compress the medium P in a read area and makes it flat. As a result, an image read by the image reading part 170 becomes a flat image, not distorted image.

The projection member 150 includes taper parts 152 and 154, and an edge line 153 between both taper parts 152 and 154 compresses the medium P. The instant embodiment arranges the contact points CP just below the centerline orthogonal to the width direction WD on the image-reading surface 102, and biases the read window 171 to the end. Without the taper parts 152 and 154, when the image-reading surface 102 inclines, the projection member close to the end contacts and hinders smooth movements of the rollers 112 and 114. Therefore, the projection member 150 is tapered to handle with the inclination of the image-reading surface 102.

A transparent protective cover 177 is attached to the read window 171. The light source 172 is provided obliquely near and above the read window 171, and irradiates illumination light onto the medium through the read window 171. The light source 172 is made, for example, of a light-emitting diode and cold-cathode tube. The lens 174, which is provided above the read window 171, condenses, through the transparent protective cover 177, the reflected light from the medium that reflects the light from the light source 172. The sensor chip 176 includes a plurality of line sensors arranged along a straight line including an image sensor (e.g., a charge-coupled device) and a CMOS sensor, and reads one line of image data on the medium. The sensor chip 176 is provided above the lens 174, and output as image data for each line the reflected light condensed by the lens 174 that has been converted into an electronic signal. The sensor chip 176 is provided on the control board 106 onto which the control part 107 and the image processing part 108 are mounted.

The transparent protective cover 177 is attached to cover the read window 171, and shields the housing 101 from dust, protecting the optical system elements, such as the lens 174.

The perforation hole 179 is provided at the side of the board 106 in the housing 170a, which is a groove-shaped housing component that does not cause the molding manufacture complex. Since it uses a dead space above the light source or light guide member 172, it does not shield an optical path in the optical system. A unit of the housing 172a may be assembled and inspected as a single member without assembling the shaft 114 by the same procedure as a type that does not perforate the shaft. The size of the component usually has tolerance to account for the manufacture error, but the assembly conceivably creates an aperture that causes the roller 112 to be rickety in the longitudinal direction LD. In order to prevent this, a shaft often includes steps at a bearing portion in the roller 112 to position the roller 112 relative to the housing 101. However, the step would require the board 106 to be removed and assembled, and the image reading part 107 is required to be inspected and adjusted. The structure of this embodiment improves the operability by eliminating the re-inspection and readjustment of the image reading part 170.

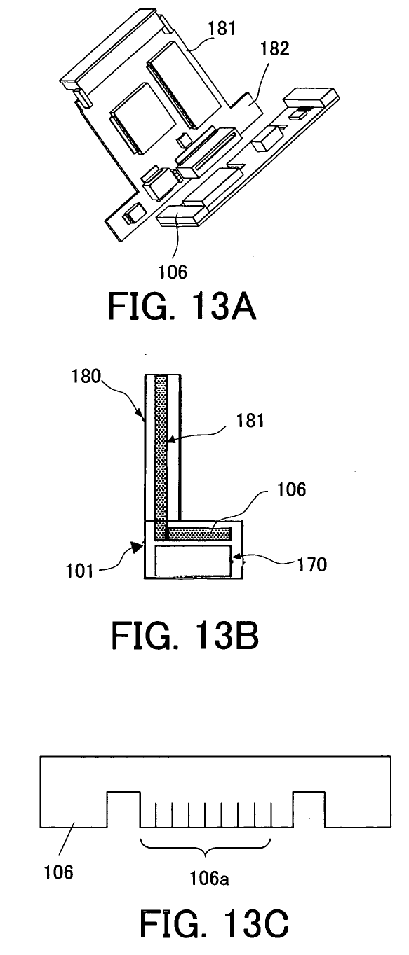

The CF card 180 is an interface that enables the housing 101 as a scanner part to be mounted onto the PDA 10. A description will now be given of the board arrangement with reference to FIG. 13. Here, FIG. 13A is a perspective view showing an arrangement between the board 181 in the CF card 180 and the control board 106. FIG. 13B is its sectional view. FIG. 13C is a schematic plane view for explaining a connection part with a connector formed on the control board 106. FIG. 13 is a view for explaining an embodiment that improves operability by lowering the height of the image reader 100.

An input device that does not contact the medium, such as a camera, does not affect operability even when this increases the height of the PDA 10 where an interface part of the PDA 10 projects from the end of the information processor and its top is mounted with a camera part for inputting an image. On the contrary, the image reader 100 that contacts the medium and has the large height of the housing 101 in the direction HD shown in FIG. 3 would shift up the center-of-gravity position, lowering the stability when the image reader 100 moves for scanning. Accordingly, the instant embodiment provides the board 181 with the connector 182 in the CF card 180 and the control board with the connection part 106 connectible with the connector 182 as shown in FIG. 13C, thereby connecting the board 181 and 106 perpendicular to each other, as shown in FIG. 13B. Such an L-shape connection would lower the height of the housing 101 and thus the center-of-gravity position while maintaining the mountable area, thereby stabilizing the scan movement and operability of the image reader 100.

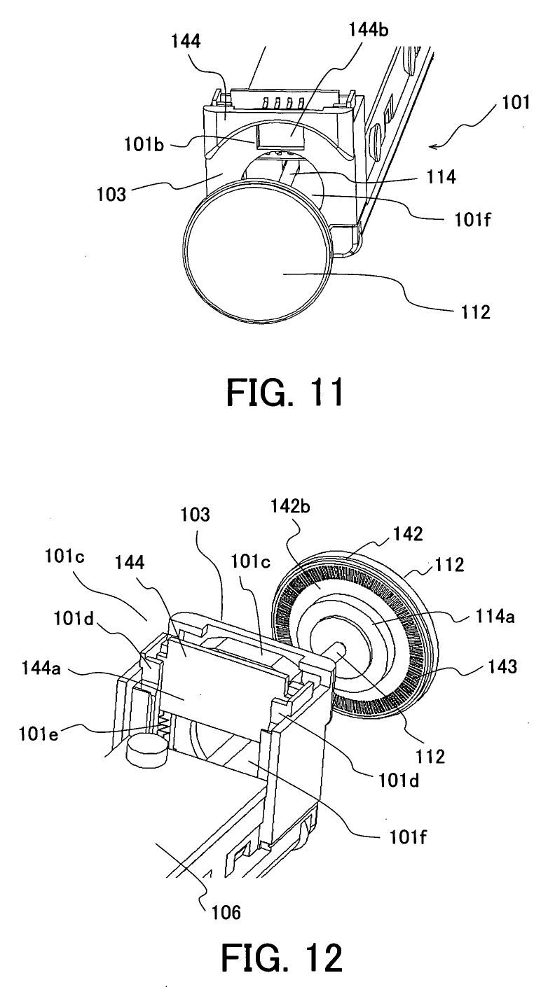

A description will now be given of a rotary encoder 140 as a scan amount detection part with reference to FIGS. 11 and 12. Here, FIGS. 11 and 12 are views showing an essential internal structure near the rotary encoder 140 in the image reader 100. FIG. 11 is a perspective view of the image reader 100 from the outside of the housing 101, i.e., a side of the main roller 112, to the inside of the housing 101. FIG. 12 is a perspective view of the image reader 100 from the inside of the housing 101 to the outside of the housing 101.

The rotary encoder 140 detects the scan amount of the image reader 100 by detecting the rotational amount of the main roller 112, and includes a scaler 142, and a reflection-type optical sensor 144 as a photo detector part. Of course, the photo detector is not limited to the reflection-type optical sensor 144, but may use a transmission-type optical sensor, such as a photo-interrupter, and other known optical detector elements, such as a PSD sensor.

The scaler 142 moves as the image reading part 170 scans, and is arranged oblique to the vertical scanning direction (or a width direction) orthogonal to the horizontal scanning direction (or a scanning direction in reading images). The instant embodiment 142 is an approximately disc-shaped member with a hollow cylinder or ring shape, which is arranged, for example, orthogonal to the vertical scanning direction, and has plural line patterns 143 on its side surface 142b. The line pattern 143 formed on the side surface 142b facilitates a low profile of the scaler 142 in the width direction (or vertical scanning direction), and miniaturizes the image reader 100 in the width direction. Instead, for example, the linear stability of the image reader 100 can improve upon scanning when the scaler 142 is made thin and thus the main roller 112 can be made long in the vertical scanning direction.

As illustrated, the instant embodiment arranges the side surface 142b parallel to a plane orthogonal to the vertical scanning direction, but the present invention is not limited to this arrangement. For example, the side surface 142b may be arranged oblique to the rotary axis of the main roller 112 by a predetermined angle, if necessary. The reflection-type optical sensor 144 is properly arranged according to the orientation of the line pattern 143 formed on the side surface 142b.

As shown in FIG. 12, the line pattern 143 is formed on a perimeter of the scaler 142 around a rotational center of the main roller 112 in a radial direction, and arranged near the peripheral of the scaler 142 at a regular interval. The patterning process for manufacturing the scaler 142 of the instant embodiment may use etching, laser processing, etc. While the instant embodiment forms it radially around the rotational center of the main roller 112, the line pattern 143 can be radially formed around a rotational center axis that is geared with the rotational center axis of the main roller 112. It does not have to be formed radially only if it is a predetermined shaped pattern detectable by the photo detector.

The scaler 142 forms a center hole (not shown) near the disc center. The main roller 112 forms, near its rotational center, a boss 113 that extends along a rotational center axis (see FIG. 8), and the shaft 114 of the main roller 112 and the boss 113 are inserted into the center hole. For example, the instant embodiment integrates the main roller 112 and the scaler 142 with each other. Therefore, the main roller 112 and the scaler 142 are fixed around the shaft 114 and rotate together synchronously. The main roller 112 and the scaler 142 are provided outside the housing 101 in the instant embodiment.

A provision of the scaler 142 outside the housing 101 can enlarge the outer diameter of the scaler 142 irrespective of the size of the housing 101. The rotary encoder 140 may improve the resolution with the fine line pattern 142 or the smaller pattern angular interval of the line pattern 143. Therefore, the scan amount-of the image reader 100 is detectable more accurately.

The reflection-type optical sensor 144 optically identifies the line pattern 143 of the scaler 142 using projection/reception light, and includes a light-emitting element and a light-receiving element in a package. It projects light onto a target and recognizes it by receiving the reflection light. The reflection-type optical sensor 144 arranges an exit surface 144b oblique to the horizontal scanning direction, and the exit surface 144b emits detection light for optically detecting a scan amount. The instant embodiment arranges the exit surface 144b in the vertical scanning direction, and this reflection-type optical sensor 144 is provided in the housing 101. As shown in FIG. 12, the sidewall 103 of the housing 101 forms the transmission window 101b that transmits detection light by the reflection-type optical sensor 144. A contact wall loll is formed near and above the transmission window 101b.

This contact wall 101c is used to position the reflection-type optical sensor 144 relative to the transmission window 101b, and integrated with the sidewall 103 of the housing 101 so that it projects towards the inside of the housing 101. Its shape fits the shape of the reflection-type optical sensor 144, and a contact with the side surface of the reflection-type optical sensor 144 can easily and precisely position the sensor 144.

As shown in FIG. 12, for example, the sensor board 144b is inserted into the rail 101d from the bottom, the side surface of the reflection-type optical sensor 144 contacts the contact wall 101c, and the elastic member 101e, such as a spring, rubber, and plastic, forces the reflection-type optical sensor 144 from the bottom. This easily and precisely attaches the reflection-type optical sensor 144 to the sidewall 103 of the housing 101.

The reflection-type optical sensor 144 is attached in the housing 101 above the control board 106 of the image reading part 170. Therefore, the reflection-type optical sensor 144 does not enlarge the size of the image reader 100 in the vertical scanning direction or require a reduction of the image reading part 170. The image reading surface 102 may be made larger in the vertical scanning direction for enough image reading area by taking advantage of the size of the housing 101 in the vertical scanning direction.

The housing 101 has a hole part 101f in the sidewall 103, into which the shaft 114 of the main roller 112 and the boss 113 are inserted. The main roller 112 and the scaler 142 are attached to the sidewall 103 from the outside of the housing 101 by inserting the shaft 114 of the main roller 112 and the boss 113 into the hole part 101f and the bearings 114a for pivoting the main roller 112 on the sidewall 103 of the housing 101.

The bearings 114a may be of a thrust or radial type. The bearings 114a of the thrust type forms the boss 113 higher than the thickness of the hole part 101f, makes a diameter of the hole part 101f approximately equal to that of the boss 113, and allows the boss 113 to be engaged with the hole part 101f. The main rollers 112 rotate smoothly since the bearings 114a contact the scaler 142 and the sidewall 103 so that the scaler 142 does not directly contact the sidewall 103.

The bearings 114a of the radial type make a diameter of the hole part 101f approximately equal to that of the bearing 114a, and allow the bearing 114a to be engaged with the hole part 101f. The main rollers 112 rotate smoothly since the boss 113 and the hole part 101f are held via the bearings 114a.

Since the main roller 112 and the scaler 142 are integrated and attached to the sidewall 103 from the outside of the housing 101, the scaler 142 does not have to be attached in the housing 101 after the shaft 114 is inserted into the hole part 101f This facilitates assembly even when a diameter of the bearing 114a is smaller than that of the main roller 112 or the scaler 142.

A reduced diameter of each of the boss 113 and the bearings 114a without deteriorating the assembly operation lowers the rotational friction of the main roller 112, and rotates the main roller 112 smoothly.

A description will now be given of the operation of the image reader 100. The control part 107 determines whether the console part 12 on the PDA 10 has been operated or the medium detecting part 160 has detected the medium. The operation of the console part 12 is an activation for setting the image reading part 170 to a readable state. The control part 107 does not run the image reading part 170 until it determines that the console part 12 on the PDA 10 has been operated or the medium detecting part 160 has detected the medium. When the control part 107 determines that the console part 12 on the PDA 10 has been operated or the medium detecting part 160 has detected the medium, the control part 107 runs the image reading part 107 after designating (or setting up) the number of lines in the image data to be read. Here, the number of lines means the number of lines in the scan or read direction R of the image reader 100 on the paper, and a readable area by the image reader 100 corresponds to the number of lines multiplied with a width in the longitudinal direction of the image read window 101b.

The former case would be implemented in a PDA of such a device type that arranges the console part 12 above the display part 14 or in the PDA that arranges the console part 12 under the display part 14 but is low. The latter case is implemented when the medium detection signal or ON signal is transmitted from the medium detecting part 160 to the control part 107. The instant embodiment thus enables the image reading part to be set to an automatic readable state as a result of a detection of the medium by the medium detecting part 160, and the user thus does not have to operate the console part 12 and feels improved operability when the holding part at which the user holds the PDA 10 and the image reader 100 shown in FIG. 2 is apart from the console part 12.

Then, a user starts reading an image on the medium, such as a book or manuscript, by approaching the end of the housing 101 of the image reader 100 to the reading start position. As shown in FIG. 10B, the image-reading surface 102 slightly inclines relative to the medium with respect to a line connecting the contact points CP between a pair of main rollers 112 and the medium, but the auxiliary rollers 116 prevent great inclination. In addition, the projection member 150 makes the medium flat near the read window 171, and maintains the quality of images to be read. The read window 171 may easily read images near the center part in a foldable book since the read window 171 is biased to the end on the image-reading surface 102 in the scan direction R.

As shown in FIG. 5, the image reading part 170 has the perforation hole 179 through which the shaft 114 perforates, and the boards 106 and 181 are connected perpendicularly or like an L-shape, as shown in FIG. 13, the height of the housing 101 and thus the center-of-gravity are maintained to be low and the scan movement of the housing 101 is stabilized. The main rollers 112 is pivoted on the sidewall 103 of the housing 101 through the bearings 11 4a and causes small rotational friction enough to maintain the smooth movement, as shown in FIG. 11. In addition, such a structure may make the clearance small between the main roller 112 and the housing 101, and prevents the unstable scan movement of the main roller 112. The reinforcing member 198 shown in FIG. 6 that is inserted as required prevents the binding stress to apply to the CF card 180 between the housing 101 and the PDA 10 during the scan movement.

Since a pair of main rollers 112 are connected to the shaft 114, their rotations are synchronized and the shaft 114 is connected to the scaler 142. The moving amount of the image reader 100 is detected with precision by the scaler 142 having high resolution in the scan amount detection part 140.

The control part 107 sequentially outputs a read control signal to the image reading part 170 at a predetermined period. The read control signal may be prepared by utilizing the detection result by the scan amount detection part 140. The image reading part 170 outputs to the image processing part 108, image data for one line on the medium and the detection result by the scan amount detection part 140 for each input of the read control signal. The image data is digitized by the image processing part 108 and input in the control part 107. The control part 107 transmits data for every one or several lines to the PDA 10, and enables a memory (not shown) to store the data, the display part 14 to display the data, and/or the console part 12 to edit the data.

Then, the control part 107 determines whether the console part 12 on the PDA 10 has been operated or the medium detecting part 160 does not detect the medium. The operation of the console part 12 means the operation for stopping reading by the image reading part 170. The control part 107 allows the image reading part 170 to continue to read the medium until the console part 12 on the PDA 10 has been operated or the medium detecting part 160 does not detect the medium. As described above, according to the instant embodiment, a user does not have to operate the console part 12 and feels improved operability in the latter case, because the OFF signal is sent from the medium detecting part 160 to the control part 107 to automatically stop reading by the image reading part 170. More specifically, the user simply heaves the image reader 100 from the medium; whereby the control part 107 instructs the image reading part 170 to automatically finish the image reading action.

As discussed, according to the image reader 100 of the instant embodiment, the scaler 142 has the side surface 142b with plural line patterns and reduces its size in the vertical scanning direction. Therefore, the image reader 100 may reduce its size in the vertical scanning direction.

An outer diameter of the scaler 142 may increase by providing the scaler 142 outside the housing 101 without being affected by the size of the housing 101. The rotary encoder 140 may improve the resolution with the smaller pattern angular interval of the line pattern 143, and accurately detect the scan amount of the image reader 100.

Since the housing 101 accommodates the reflection-type optical sensor 144 and the sidewall 103 forms the transmission window 101b and contact wall 101c, the image reader may entirely reduce its size without causing any projection for a photo detector part outside the housing and position easily and precisely the reflection-type optical sensor 144. The reflection-type optical sensor 144 does not enlarge the size of the image reader 100 in the vertical scanning direction or the image reading part 170 does not have to be made small. The image reading surface 102 may be made larger in the vertical scanning direction for enough image reading area by taking advantage of the size of the housing 101 in the vertical scanning direction.

Since the main roller 112 and the scaler 142 are integrated and attached to the sidewall 103 from the outside of the housing 101, the scaler 142 does not have to be attached in the housing 101 after the shaft 114 is inserted into the hole part 101f. This facilitates assembly even when a diameter of the bearing 114a is smaller than that of the main roller 112 or the scaler 142.

A reduced diameter of each of the boss 113 and the bearings 114a without deteriorating the assembly operation lowers the rotational friction of the main roller 112 and rotates the main roller 112 smoothly.

Further, the present invention is not limited to these preferred embodiments, and various modifications and changes may be made in the present invention without departing from the spirit and scope thereof. For example, the PDA 10 of this embodiment has a CF slot, the PDA 10 may be connected to an external unit having a CF slot instead of providing the PDA 10 itself with the CF slot. In this case, the PDA 10 may be fixed onto this external unit mechanically through screws etc., or connected electrically. The CF card 180 may be inserted into the external unit and adapted to electrically communicate with the PDA 10 when the external unit is used.

The above embodiment provides the scaler 142 outside the housing 101, enlarges a diameter of the scaler 142, and effects improved resolution of the rotary encoder 140.

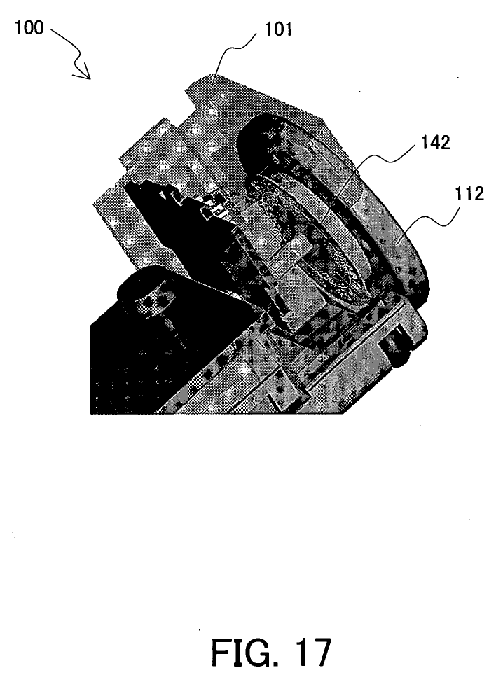

On the other hand, the scaler 142 that is provided on the sidewall 103 of the housing 101, as shown in FIG. 17 may further reduce the size of the image reader 100 in the vertical scanning direction. The above embodiment needs to maintain the thickness of the scaler 142 outside the housing 101 in the vertical scanning direction, while the instant embodiment accommodates the scaler 142 in the housing 101 and promotes miniaturization of the image reader 100.

In addition, since the housing 101 covers and protects the scaler 142, the external influence cannot damage or dirt the scaler 142. No dusts adhere to the scaler 142. This feature improves the maintainability of the image reader 100 improves and prolongs its product life.

Although not shown, when the main rollers 112 are accommodated in the housing 101, the invisible main rollers 112 from the outside of the housing 101 improve appearance in addition to the miniaturization of the image reader 100 in the vertical scanning direction.

Thus, the present invention may provide an image reader that has such a structure as facilitates miniaturization and reduces its size in the width direction (or the vertical scanning direction).

1. An image reader, detachably attached to an electronic apparatus, which scans and reads an image formed on a surface to be read, said image reader comprising:
an image reading part that reads the image; and
a scan amount detection part that detects a scan amount by said image reading part, said scan amount detection part including a scaler that is arranged oblique to a vertical scanning direction orthogonal to a horizontal scanning direction, and moves along with scanning by said image reading part.

2. An image reader according to claim 1, wherein the scaler is arranged orthogonal to the vertical scanning direction.

3. An image reader according to claim 1, wherein the scaler has a radial line pattern.

4. An image reader according to claim 1, further comprising:
a rotary shaft that extends in the vertical scanning direction; and
a main roller provided around the rotary shaft and integrated with the scaler.

5. An image reader according to claim 1, further comprising a housing that accommodates said image reading part, wherein the main roller is located outside the housing and larger than the housing.

6. An image reader according to claim 1, further comprising:
a housing that accommodates said image reading part, said housing having a hole;
a main roller that moves said housing in the horizontal scanning direction;
a boss formed at a center of said main roller and engageable with the hole in said housing; and
a bearing provided around said boss, wherein said scaler is formed around said bearing.

7. An image reader, detachably attached to an electronic apparatus, which scans and reads an image formed on a surface to be read, said image reader comprising:
an image reading part that reads the image; and
a scan amount detection part that detects a scan amount by said image reading part, said scan amount detection part including a photo detector part that arranges oblique to a horizontal scanning direction an exit surface that detects detection light used to optically detect the scan amount.

8. An image reader according to claim 7, wherein said photo detector part arranges the exit surface in a vertical scanning direction orthogonal to the horizontal scanning direction.

9. An image reader according to claim 7, further comprising a positioning part that positions the photo detector part.

10. An image reader according to claim 9, wherein said scan amount detection part further includes a scaler that is arranged oblique to a vertical scanning direction orthogonal to the horizontal scanning direction, and moves along with scanning by said image reading part,
wherein said image reader further comprises a housing that accommodates said image reading part and the photo detector part, and
wherein the scaler is arranged outside of the housing, while the positioning part is formed on said housing between the photo detector part and the scaler, and includes a transmission window that transmits the detection light.

11. An image reader, detachably attached to an electronic apparatus, which scans and reads an image formed on a surface to be read, said image reader comprising:
an image reading part that reads the image;
a scan amount detection part that detects a scan amount by said image reading part, said scan amount detection part including a scaler that moves with scanning by said image reading part;
a rotary shaft that extends in a vertical scanning direction orthogonal to a horizontal scanning direction; and
a main roller provided around the rotary shaft, wherein the scaler is integrated with said main roller.

12. An image reader according to claim 11, wherein said scaler is arranged adjacent to and integrated with a side of said main roller, and includes a radial line pattern.
